(19) United States
(12) Patent Application Publication
(10) Pub. No.: US 2022/0039351 A1
(43) Pub. Date: Feb. 10, 2022

(54) AUTOMATIC PET FOOD SUPPLIER

(71) Applicants: Taehyoung KIM, Seoul (KR); Sanghyuk KIM, Seoul (KR)

(72) Inventors: Taehyoung KIM, Seoul (KR); Sanghyuk KIM, Seoul (KR)

(21) Appl. No.: 17/384,099

(22) Filed: Jul. 23, 2021

(30) Foreign Application Priority Data
Aug. 4, 2020 (KR) 10-2020-0097459

(51) Int. Cl. A01K 5/02

(52) U.S. Cl. CPC A01K 5/0225; A01K 5/0275; A01K 5/0291

(57) ABSTRACT

Provided is an automatic pet food supplier for a pet. The automatic pet food supplier may allow a body to constantly remain in a level condition on the floor through a height-adjusting function and simply disassemble a storage container from the body and a pet food discharger from the storage container. Here, blades configured to discharge pet food are arranged to seal a pet food discharge opening.

### BACKGROUND

### 1. Field of the Invention

The present invention relates to an automatic pet food supplier for pets which constantly supplies pet food to pets (for example, dogs, cats, and the like) according to a set time.

### 2. Discussion of Related Art

Generally, in raising pets such as a dog, cat, and the like, since most pet food is manually supplied piece by piece, it is difficult to adjust a supply time and a supply amount.

Particularly, since it is impossible to supply pet food when a house is left empty for a long time due to an outgo, a vacation, or the like, pet(s) are left in additional care facilities or the like. In this case, a considerable cost is necessary. Accordingly, conventionally, a variety of automatic pet food suppliers have been disclosed.

However, although a variety of conventional automatic pet food suppliers are designed so that a motor is driven according to a set time and a rotor including a single or plurality of transfer screws or gear teeth is rotated so as to discharge pet food, since a coupling structure thereof is complicated, and particularly, disassembling is difficult due to coupling relations of components, it is hard to completely perform a cleaning operation on an inside thereof.

That is, in such automatic pet food suppliers, when pet food is stored in a storage container and periodically discharged, residues of the pet food may be smeared on not only the storage container but also a discharge path thereof. Here, since it is difficult to disassemble such conventional automatic pet food suppliers, a user has a difficulty in directly cleaning an inside thereof and it is necessary to request after-sales service in order to clean the inside.

Also, in a variety of conventional automatic pet food suppliers, since a pet food discharge hole is not sealed, there is a problem in which pet food is unnecessarily discharged.

That is, when the automatic pet food supplier is moved or a body thereof is placed on an uneven bottom surface, there are a large number of cases in which pet food is unnecessarily discharged through the pet food discharge hole which is not sealed.

In addition, in a variety of conventional automatic pet food suppliers, there are a large number of cases in which the body thereof is not properly maintained in a level condition due to the bottom surface which is uneven. In this case, pet food is not adequately discharged and not provided to a pet at a set time when the user goes out without recognizing this.

### SUMMARY OF THE INVENTION

The present invention is directed to providing an automatic pet food supplier which is simply disassembled so as to allow a user to easily perform a cleaning operation.

The present invention is also directed to providing an automatic pet food supplier configured to uniformly remain in a level condition using a height adjusting function so as to remedy a problem in which, when a pet having a different body type eats pet food, the pet's head is bent downward and pressure is put on a stomach so that acute indigestion or vomiting is caused.

The present invention is also directed to providing an automatic pet food supplier configured to prevent pet food from being unnecessarily discharged by sealing a pet food discharge opening when the pet food is not discharged.

According to an aspect of the present invention, there is provided an automatic pet food supplier for a pet. The automatic pet food supplier includes a body portion configured to accommodate a motor driven according to a set automatic pet food discharge mode or a manual manipulation signal of a manipulation portion, a pet food case detachably mounted on one end of a top surface of the body portion and including a bottom end in which a first discharge opening is formed and a top end which is opened and covered by a cover, a support disposed at a bottom end of an inside of the pet food case to be detachably coupled to the top surface of the body portion to accommodate the motor and including a first guide portion tilted toward the first discharge opening, a pet food storage container disposed at a top end of the inside of the pet food case to be supported by the support, in which pet food mounted on the first guide portion and discharged into the first discharge opening is stored, and including a tilted discharge rod mounted on a second discharge opening and the first guide portion, a rotor detachably mounted on a bottom end of an inside of the pet food storage container to be connected to a driving shaft of the motor accommodated in the support and rotate and in which discharge blades are radially arranged on an outer circumferential surface to discharge a fixed amount of pet food into the first discharge opening through the discharge rod when the motor is driven, and a pet food container portion detachably mounted on the other end of the top surface of the body portion and configured to accommodate the fixed amount of pet food when the fixed amount of pet food is discharged through the first discharge opening.

A first mounting hole, on which the pet food container portion is mounted, may be formed in the other end of the top surface of the body portion, and one or more first elastic support protrusions configured to support an edge part of the mounted pet food container portion may be formed on the first mounting hole.

A second mounting hole on which the pet food case is mounted may be formed in the one end of the top surface of the body portion, and one or more second elastic support protrusions configured to support an edge part of the mounted pet food case may be formed on the second mounting hole.

The motor may be formed on the one end of the top surface of the body portion to be protected by a protection case to expose only a driving shaft, and the protection case may include a second guide portion which is tilted and on which the first guide portion is mounted and one or more first boss portions configured to couple and fix the support.

The motor may be a step motor in which, when an automatic pet food discharge mode is stopped, a pair of discharge blades among the discharge blades radially arranged on the outer circumferential surface of the rotor are disposed on an end of one side and an end of the other side of the second discharge opening to form a barrier.

The support may be a structure having a space which accommodates the protection case, in which one or more second boss portions pressed against the first boss portions are formed to protrude from a bottom end of an outer circumferential side of the structure and a pair of coupling frames are formed to protrude from a top end of the outer circumferential side of the structure.

The pet food storage container may be a transparent plastic injection-molded material and may include a first storage container having a first diameter and in which pet food is stored and a second storage container which is formed at a bottom end of the first storage container, extends to have a second diameter smaller than the first diameter, and is configured to receive the pet food from the first storage container. Also, the first storage container may have a tilted surface for dropping the inserted pet food to the second storage container, and the second storage container may accommodate the rotor.

A pair of frame mount grooves, in which the coupling frames are mounted, may be formed in an outer circumferential surface of the first storage container.

A blade coupling groove may be radially formed in an edge side of a bottom surface of the rotor. Also, the discharge blades may be formed of a silicone or rubber material and may each include a coupling protrusion inserted into and coupled to the blade coupling groove, a support shaft extending from the coupling protrusion, and a blade segment formed on the support shaft and configured to discharge pet food into the second discharge opening when the pet food falls to the second storage container.

An insert nut may be formed on each corner part of the bottom surface of the body portion, and a leg portion may be detachably coupled to the insert nut using a bolt and formed of wood to be adjustable in height.

The body portion may include an electronic inclinometer configured to check a level condition with respect to the body portion.

The body portion may further include a warning sound output portion configured to output a warning sound when the body portion does not remain in a level condition according to check information of the inclinometer.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a coupled perspective view illustrating a structure of an automatic pet food supplier for pets according to an embodiment of the present invention;

FIG. 2 is an exploded perspective view illustrating the structure of the automatic pet food supplier according to the embodiment of the present invention;

FIG. 3 is a schematic cross-sectional view illustrating the structure of the automatic pet food supplier according to the embodiment of the present invention;

FIG. 4 is a schematic plan view illustrating an automatic pet food supply state according to the embodiment of the present invention;

FIG. 5 is an enlarged cross-sectional view illustrating a coupling structure of a leg portion according to the embodiment of the present invention;

FIG. 6 is an enlarged perspective view illustrating a structure of a rotor including discharge blades according to the embodiment of the present invention; and

FIG. 7 is an enlarged view illustrating a pet food discharge flow according to the embodiment of the present invention.

### DETAILED DESCRIPTION OF EXEMPLARY EMBODIMENTS

Advantages and features of the present invention and methods for achieving them will be made clear from an embodiment described in detail below with reference to the accompanying drawings. However, the technical concept of the present invention is not limited to the embodiment which will be described below and may be implemented as a variety of different shapes. It should be noted that the embodiment is provided merely for completing the disclosure of the present invention and allowing one of ordinary skill in the art to understand the complete scope of the present invention and the technical concept of the present invention will be defined by the claims.

Terms used herein are for the purpose of describing the embodiment and are not intended to limit the present invention. Throughout the specification, the singular forms include the plural forms as well unless the context clearly indicates otherwise.

Throughout the specification, the terms “comprise,” “have,” and the like are used herein to specify the presence of stated features, numbers, stages, operations, elements, components or combinations thereof but do not preclude the presence or addition of one or more other features, numbers, stages, operations, elements, components, or combinations thereof.

Also, the embodiment disclosed herein will be described with reference to cross-sectional views and/or plan views which are exemplary views of the present invention. Accordingly, it should be noted that the embodiments of the present invention are not limited to the particular forms shown in the drawings but include necessary changes in form. For example, an area shown as being rectangular may have a shape which is rounded or has a certain curvature. Accordingly, areas shown in the drawings have schematic properties, and shapes of the areas shown in the drawings are to exemplify particular shapes of a device area and not to limit the scope of the present invention.

Throughout the specification, like reference numerals refer to like elements. Accordingly, although not stated or shown in the corresponding drawing, like reference numerals or similar reference numerals may be described with reference to other drawings. In addition, although a reference numeral is not shown in the drawing, the reference numeral may be described with reference to other drawings.

Hereinafter, an embodiment of the present invention will be described in detail with reference to the attached drawings.

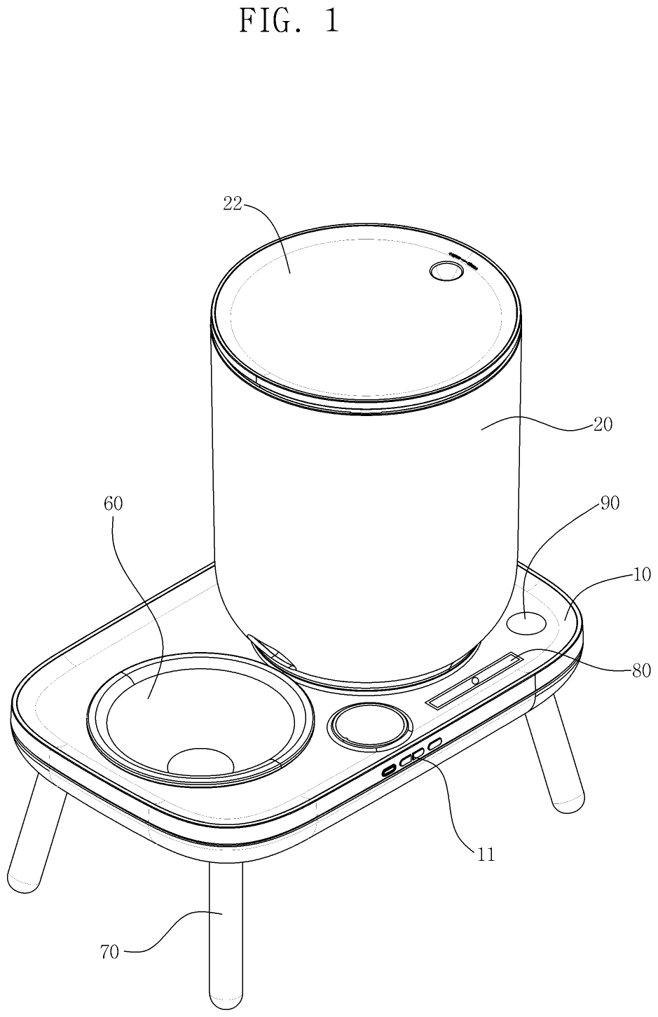

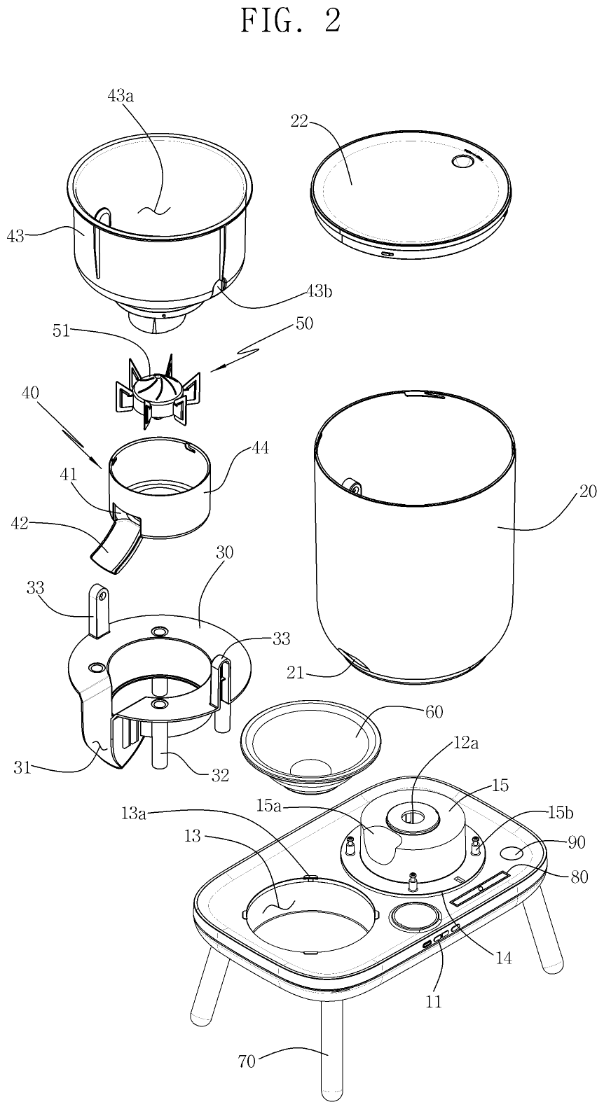

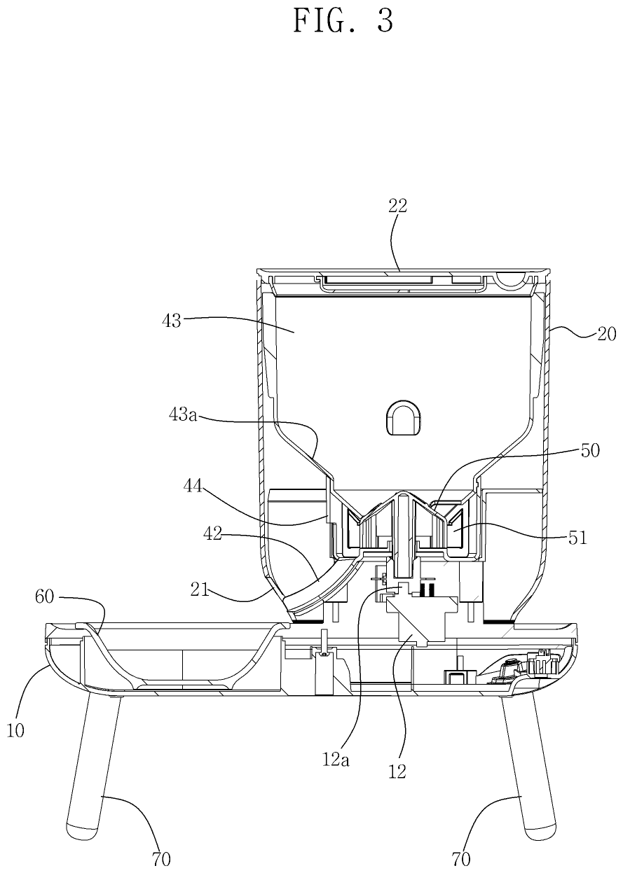

FIG. 1 is a coupled perspective view illustrating a structure of an automatic pet food supplier for pets according to an embodiment of the present invention, FIG. 2 is an exploded perspective view illustrating the structure of the automatic pet food supplier according to the embodiment of the present invention, and FIG. 3 is a schematic cross-sectional view illustrating the structure of the automatic pet food supplier according to the embodiment of the present invention.

Referring to FIGS. 1 to 3, the automatic pet food supplier according to the embodiment of the present invention may include a body portion 10, a pet food case 20, a support 30, a pet food storage container 40, a rotor 50 including discharge blades 51, and a pet food container portion 60.

The body portion 10 is a panel-type structure in which a motor 12 configured to be driven according to a manual manipulation signal of a manipulation portion 11 or a set automatic pet food discharge mode may be accommodated.

Here, as a first mounting hole 13, on which the pet food container portion 60 is mounted, is formed on another end of a top surface of the body portion 10, one or more first elastic support protrusions 13a configured to support an edge part of the mounted pet food container portion 60 may be formed on the first mounting hole 13.

Here, as a second mounting hole 14, on which the pet food case 20 is mounted, is formed on one end of the top surface of the body portion 10, one or more second elastic support protrusions 14a configured to support an edge part of the mounted pet food case 20 may be formed on the second mounting hole 14.

Meanwhile, the motor 12 may be configured to be protected by a protection case 15 so as to expose only a driving shaft 12a on the one end of the top surface of the body portion 10. Here, in the protection case 15, a second guide portion 15a which is tilted and on which a first guide portion 31, which will be described below, is mounted and one or more first boss portions 15b configured to couple and fix the support 30 may be formed to protrude.

Here, the motor 12 is a step motor configured to a barrier by disposing one pair of discharge blades 51 among the discharge blades 51 radially arranged on an outer circumferential surface of the rotor 50 on one end and the other end of a second discharge opening 41 which will be described, respectively, when the automatic pet food discharge mode is stopped.

That is, although the motor 12 discharges pet food inserted between the pair of discharge blades 51 among the discharge blades 51 radially arranged on the outer circumferential surface of the rotor 50 through the second discharge opening 41 by rotating to rotor 50 in the automatic pet food discharge mode, when the automatic pet food discharge is finished, the pair of discharge blades 51 are stopped at one end and the other end of the second discharge opening 41 and perform a barrier function so as to stop pet food discharge through the second discharge opening 41.

The pet food case 20 is detachably mounted on the one end of the top surface of the body portion 10 wherein the pet food case 20 includes the first discharge opening 21 formed in a bottom end thereof and an open top end covered by a cover 22.

The support 30 is disposed at a bottom end of an inside of the pet food case 20 and is detachably coupled to the top surface of the body portion 10 to accommodate the motor 12 and may include the first guide portion 31 tilted toward the first discharge opening 21.

Here, the support 30 has a structure having a space which accommodates the protection case 15 in which one or more second boss portions 32 pressed against the first boss portion 15b may protrude from a bottom end of an outer circumferential side of the structure and a pair of coupling frames 33 may protrude from a top end of the outer circumferential side of the structure.

The pet food storage container 40 is disposed at a top end of the inside of the pet food case 20 and supported by the support 30, stores pet food mounted on the first guide portion 31 and discharged into the first discharge opening 21, and includes the second discharge opening 41 and a tilted discharge rod 42 mounted on the first guide portion 31.

That is, the pet food storage container 40 is a transparent plastic injection-molded material and is divided into a first storage container 43 configured to store pet food and have a first diameter and a second storage container 44 extending from a bottom end of the first storage container 43 to have a second diameter smaller than the first diameter and receive pet food falling from the first storage container 43. Here, a tilted surface 43a configured to allow injected pet food to fall to the second storage container 44 is formed on the first storage container 43 and the rotor 50 is accommodated in the second storage container 44.

Here, a pair of frame mount grooves 43b on which the coupling frames 33 are mounted may be formed in an outer circumferential surface of the first storage container 43.

That is, while the support 30 is mounted on the bottom end of the inside of the pet food case 20, the pet food storage container 40 is mounted on the top end of the inside of the pet food case 20. Here, the coupling frames 33 of the support 30 are mounted on the frame mount grooves 43b of the pet food storage container 40 so that the support 30 and the pet food storage container 40 may form a stacked structure inside the pet food case 20.

The rotor 50 is detachably mounted inside the second storage container 44 at the bottom end of the inside of the pet food storage container 40 and is rotatably connected to the driving shaft 12a of the motor 12 accommodated in the support 30 and includes multistage discharge blades 51 radially arranged on an outer circumferential surface thereof to discharge a fixed amount of pet food into the first discharge opening 21 through the discharge rod 42 when the motor 12 is driven.

Here, a blade coupling groove 50a may be radially formed on an edge side of the bottom surface of the rotor 50. The discharge blade 51 has a silicone or rubber material and may include a coupling protrusion 51a inserted into and coupled to the blade coupling groove 50a, a support shaft 51b extending from the coupling protrusion 51a, and a blade segment 51c formed on the support shaft 51b and configured to discharge pet food into the second discharge opening 41 when the pet food falls to the second storage container 44.

The pet food container portion 60 is detachably mounted on the other end of the top surface of the body portion 10 to accommodate a fixed amount of pet food when the fixed amount of pet food is discharged through the first discharge opening 21.

That is, pet food for pets is put into the pet food container portion 60.

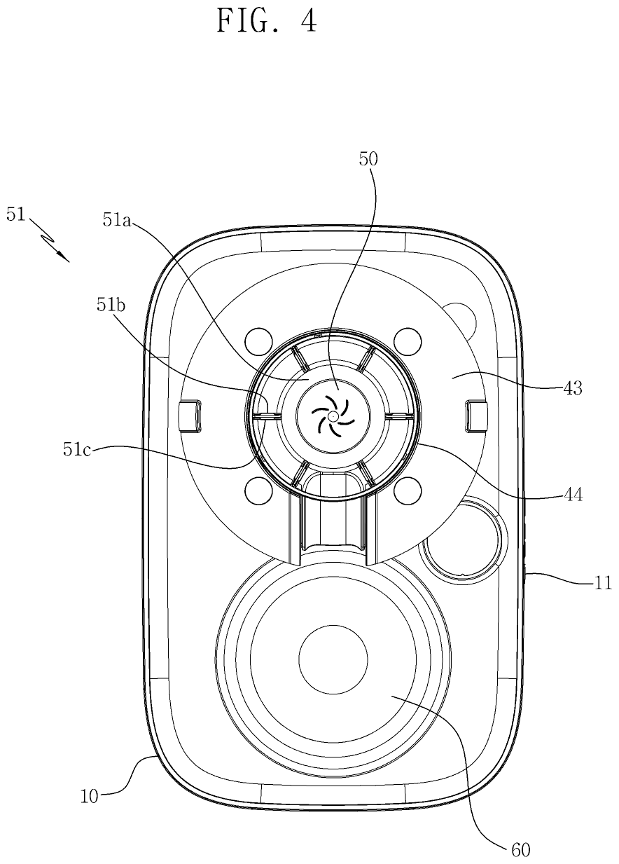

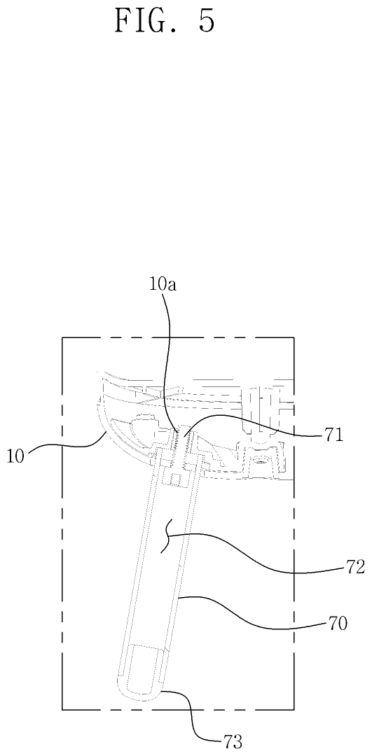

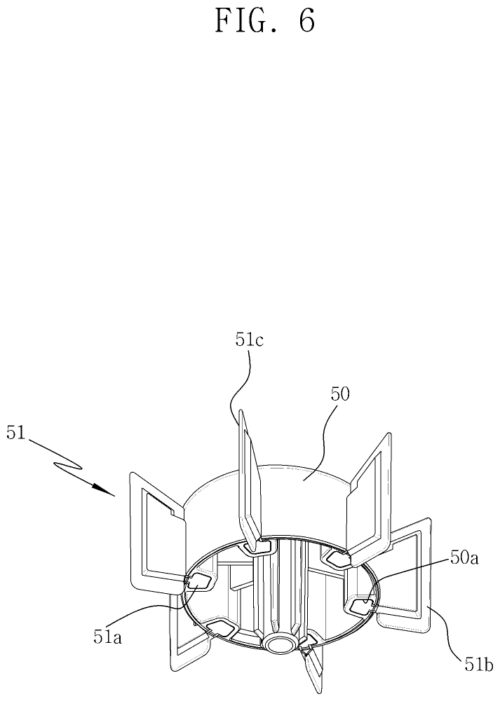

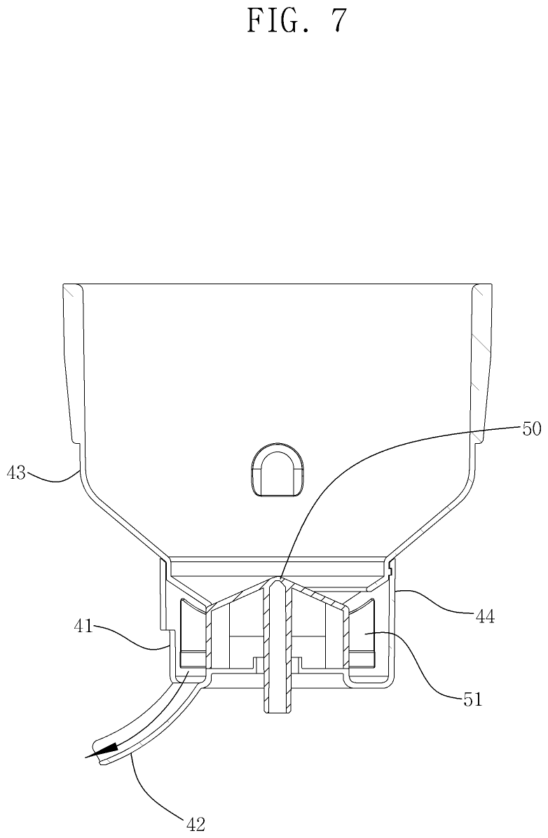

As described above, in the automatic pet food supplier according to the embodiment of the present invention, as shown in FIGS. 1 to 7, the pet food case 20 including the first discharge opening 21 is mounted on the second mounting hole 14 formed in the one end of the top surface of the body portion 10.

Then, one or more second elastic support protrusions 14a formed on the second mounting hole 14 are configured to support the edge part of the pet food case 20.

Subsequently, when the support 30 is mounted on the bottom end of the inside of the pet food case 20, the support 30 may accommodate the protection case 15 of the motor 13 which protrudes from the one end of the top surface of the body portion 10. Here, the first guide portion 31 formed on the support 30 may be mounted on the second guide portion 15a, which is tilted, formed on the protection case 15 to be tilted.

Here, a screw (not shown) is fastened to the first boss portion 15b formed on the protection case 15 through the second boss portion 32 formed on the support 30 so as to fix the support 30 to the top surface of the body portion 10.

Subsequently, when the pet food storage container 40 is inserted into the pet food case 20, the second storage container 44 at the bottom end of the pet food storage container 40 may be inserted into the space in the support 30 and the coupling frames 33 formed on the support 30 may be mounted on the frame mount groove 43b formed on the outer circumferential surface of the first storage container 43 at the top end.

Here, in the second storage container 44, although the discharge rod 42 withdrawn from the second discharge opening 41 is mounted on the first guide portion 31, the discharge rod 42 is not exposed outward from the first discharge opening 21 of the pet food case 20.

Subsequently, the rotor 50 including the multistage discharge blades 51 is mounted in the second storage container 44 so as to couple the driving shaft 12a of the motor 12 to a central part of the rotor 50.

Subsequently, when the pet food container portion 60 is mounted on the first mounting hole 13 formed in the other end of the top surface of the body portion 10, the edge part of the pet food container portion 60 is supported by one or more first elastic support protrusions 13a formed on the first mounting hole 13 so as to complete assembling of the automatic pet food supplier.

Meanwhile, when power is supplied to the above completely assembled automatic pet food supplier, the motor 12 that is a step motor forms a barrier by disposing the pair of discharge blades 51, among the discharge blades 51 radially arranged on the outer circumferential surface of the rotor 50, on an end of one side and an end of the other end of the second discharge opening 41 so that the pair of discharge blades 51, which forms the barrier, prevent pet food from being discharged through the second discharge opening 41.

That is, the cover 22 is opened at the open top end of the pet food case 20 and a certain amount of pet food is inserted into the first storage container 43 of the pet food storage container 40.

Then, the pet food falls to the second storage container 44 through the tilted surface 43a of the first storage container 43 while falling between the discharge blades 51 radially formed on the outer circumferential surface of the rotor 50 formed on the second storage container 44.

That is, although the multistage discharge blades 51 are formed on the outer circumferential surface of the rotor 50 so that a fixed amount of pet food may be inserted between the pair of discharge blades 51, the pet food is not discharged outward through the second discharge opening 41.

Subsequently, when a user manually manipulates the manipulation portion 11 formed on the body portion 10 or selects the automatic pet food discharge mode through the manipulation portion 11, the motor 12 formed on the body portion 10 is driven and rotates the rotor 50. As the discharge blades 51 horizontally rotate due to rotation of the rotor 50, the fixed amount of pet food placed between the pair of discharge blades 51 may be discharged into the discharge rod 42 through the second discharge opening 41 and the fixed amount of pet food discharged into the discharge rod 42 may be supplied to the pet food container portion 60 through the first discharge opening 21 of the pet food case 20.

That is, the rotor 50 sequentially rotates by a certain distance according to driving of the motor 12 that is a step motor so that a fixed amount of pet food to be eaten by a pet may be discharged into the pet food container portion 60 according to the sequential rotation.

Meanwhile, since it is necessary to periodically clean the automatic pet food supplier after the pet food is discharged as described above, when the automatic pet food discharge mode is stopped, the user opens the cover 22 and separates the pet food storage container 40 formed of a transparent material from the pet food case 20 without using an additional tool.

Subsequently, the support 30 is separated from the protection case 15 surrounding the motor 12 by separating the screw while the rotor 50 mounted on the second storage container 44 of the pet food storage container 40 is separated, and then each of the pet food case 20 and the pet food container portion 60 is separated from the body portion 10.

Then, the rotor 50 and the pet food container portion 60 as well as the pet food case 20, the support 30, and the pet food storage container 40 may be simply cleaned by the user. Here, when they are reassembled through the above-described assembling process, the automatic pet food supplier may be used while constantly remaining in a clean state.

Meanwhile, to allow a pet to comfortably eat pet food, in the automatic pet food supplier according to the embodiment of the present invention, an insert nut 10a may be formed on the bottom surface of the body portion 10 and then a leg portion 70 formed of wood and adjustable in height using a bolt 71 may be detachably coupled thereto.

That is, the leg portion 70 includes a hollow portion 72 and an auxiliary cover 73 at one end of the leg portion 70 so that the auxiliary cover 73 may be separated and then the bolt 71 may pass through into the hollow portion 72 so as to fasten the bolt 71 to the insert nut 10a.

Accordingly, when a level condition is maintained while the height of the leg portion 70 is adjusted using the bolt 71, it is possible to prevent a problem in which when a pet having a different body type eats pet food, the pet's head is lowered so that pressure is put on a stomach and acute indigestion or vomiting is caused.

That is, hitherto, when a pet food container is placed on the floor, a pet bends its neck. Accordingly, the embodiment of the present invention tends to improve this problem.

Here, the body portion 10 may include an electronic inclinometer 80 configured to check a level condition with respect to the body portion 10. Through the electronic inclinometer 80, the height of the leg portion 70 may be adjusted and an error in supplying pet food which occurs when the body portion 10 cannot remain in the level condition may be prevented.

That is, while the body portion 10 tilts in any one direction due to an uneven ground surface or an obstacle or the like placed on the ground surface, when the rotor 50 rotates according to driving of the motor 12 and a fixed amount of pet food is discharged through the discharge blades 51, the pet food may not be adequately discharged due to the tilted body portion 10.

Accordingly, in the embodiment of the present invention, the level condition with respect to the body portion 10 is checked using the electronic inclinometer 80, and the height of the leg portion 70 is adjusted using the bolt 71 according to a result of checking so that the body portion 10 may constantly remain in the level condition and thus the fixed amount of pet food may be discharged into the pet food container portion 60.

Here, although it has been described that the user sees the level condition of the body portion 10 through the electronic inclinometer 80 with the naked eye, the body portion 10 may further include a warning sound output portion 90 configured to output a warning sound when the body portion 10 cannot remain in the level condition according to check information of the electronic inclinometer 80.

That is, when the body portion 10 is not level and the electronic inclinometer 80 checks the level condition of the body portion 10, the warning sound output portion 90 which receives a check signal of the electronic inclinometer 80 outputs a warning sound, and the user directly checks the level condition with respect to the body portion 10 according to the outputting of the warning sound and corrects the level condition by adjusting the height of the leg portion 70 using the bolt 71 so that the automatic pet food supplier according to the embodiment of the present invention may discharge the fixed amount of pet food without an error in the absence of the user when the user sets the automatic pet food discharge mode when going out.

According to the present invention, the automatic pet food supplier may allow a body to constantly remain in a level condition on the floor through a height-adjusting function and may simply disassemble a storage container from the body and a pet food discharger from the storage container. Here, blades configured to discharge pet food are arranged to seal a pet food discharge opening. Accordingly, through simple disassembling, a user may easily perform a cleaning operation. Also, while the level condition with respect to the body may be uniformly maintained, an error in discharging the pet food may be prevented. Accordingly, a problem in which when a pet having a different body type eats pet food, the pet's head is bent downward and pressure is put on a stomach so that acute indigestion or vomiting is caused may be prevented and the pet food may be prevented from being unnecessarily discharged by sealing a pet food discharge opening when the pet food is not discharged.

Effects of the present invention are not limited to the above-stated effect and other unstated effects of the present invention will be understood by those skilled in the art from the following claims.

Although the technical concept of the present invention with respect to the automatic pet food supplier has been described with reference to the attached drawings, the most preferable embodiment of the present invention is merely exemplified and does not limit the present invention.

Accordingly, the present invention is not limited to the above particular embodiment and a variety of modifications may be implemented by one of ordinary skill in the art without departing from the gist of the present invention defined in the claims and the modifications are included within the range of the claims.

What is claimed is:

1. An automatic pet food supplier for a pet, comprising:
a body portion configured to accommodate a motor driven according to a set automatic pet food discharge mode or a manual manipulation signal of a manipulation portion;
a pet food case detachably mounted on one end of a top surface of the body portion and comprising a bottom end in which a first discharge opening is formed and a top end is opened and covered by a cover;
a support disposed at a bottom end of an inside of the pet food case to be detachably coupled to the top surface of the body portion to accommodate the motor and comprising a first guide portion tilted toward the first discharge opening;
a pet food storage container disposed at a top end of the inside of the pet food case to be supported by the support, in which pet food mounted on the first guide portion and discharged into the first discharge opening is stored, and comprising a tilted discharge rod mounted on a second discharge opening and the first guide portion;
a rotor detachably mounted on a bottom end of an inside of the pet food storage container to be connected to a driving shaft of the motor accommodated in the support and rotate and in which discharge blades are radially arranged on an outer circumferential surface to discharge a fixed amount of pet food into the first discharge opening through the discharge rod when the motor is driven; and
a pet food container portion detachably mounted on the other end of the top surface of the body portion and configured to accommodate the fixed amount of pet food when the fixed amount of pet food is discharged through the first discharge opening.

2. The automatic pet food supplier of claim 1, wherein a first mounting hole, on which the pet food container portion is mounted, is formed in the other end of the top surface of the body portion, and one or more first elastic support protrusions configured to support an edge part of the mounted pet food container portion are formed on the first mounting hole.

3. The automatic pet food supplier of claim 1, wherein a second mounting hole on which the pet food case is mounted is formed in the one end of the top surface of the body portion, and one or more second elastic support protrusions configured to support an edge part of the mounted pet food case are formed on the second mounting hole.

4. The automatic pet food supplier of claim 1, wherein the motor is formed on the one end of the top surface of the body portion to be protected by a protection case to expose only a driving shaft, and
wherein the protection case comprises a second guide portion which is tilted and on which the first guide portion is mounted and one or more first boss portions configured to protrude therefrom and couple and fix the support.

5. The automatic pet food supplier of claim 1, wherein the motor is a step motor in which, when an automatic pet food discharge mode is stopped, a pair of discharge blades among the discharge blades radially arranged on the outer circumferential surface of the rotor are disposed on an end of one side and an end of the other side of the second discharge opening to form a barrier.

6. The automatic pet food supplier of claim 4, wherein the support is a structure having a space which accommodates the protection case, in which one or more second boss portions pressed against the first boss portions are formed to protrude from a bottom end of an outer circumferential side of the structure and a pair of coupling frames are formed to protrude from a top end of the outer circumferential side of the structure.

7. The automatic pet food supplier of claim 6, wherein the pet food storage container is a transparent plastic injection-molded material and comprises a first storage container having a first diameter and in which pet food is stored and a second storage container which is formed at a bottom end of the first storage container, extends to have a second diameter smaller than the first diameter, and is configured to receive the pet food fallen from the first storage container, and
wherein the first storage container has a tilted surface for dropping the inserted pet food to the second storage container, and the second storage container accommodates the rotor.

8. The automatic pet food supplier of claim 7, wherein a pair of frame mount grooves, in which the coupling frames are mounted, are formed in an outer circumferential surface of the first storage container.

9. The automatic pet food supplier of claim 8, wherein a blade coupling groove is radially formed in an edge side of a bottom surface of the rotor, and
wherein the discharge blades are formed of a silicone or rubber material and each comprise a coupling protrusion inserted into and coupled to the blade coupling groove, a support shaft extending from the coupling protrusion, and a blade segment formed on the support shaft and configured to discharge pet food into the second discharge opening when the pet food falls to the second storage container.

10. The automatic pet food supplier of claim 1, wherein an insert nut is formed on each corner part of the bottom surface of the body portion, and
wherein a leg portion is detachably coupled to the insert nut using a bolt and formed of wood to be adjustable in height.

11. The automatic pet food supplier of claim 10, wherein the body portion comprises an electronic inclinometer configured to check a level condition with respect to the body portion.

12. The automatic pet food supplier of claim 11, wherein the body portion further comprises a warning sound output portion configured to output a warning sound when the body portion does not remain in a level condition according to check information of the inclinometer.
